(19) United States
(12) Patent Application Publication
(10) Pub. No.: US 2024/0046244 A1
(43) Pub. Date: Feb. 8, 2024

(54) MOBILE POINT OF SALE VIRTUAL KEYBOARD SYSTEM

(71) Applicant: Ziina LLC, Wilmington, DE (US)

(72) Inventors: Anton BADASHOV, Dubai (AE); Andrew GOLD, Dubai (AE); Faisal TOUKAN, Dubai (AE); Afnan ABED, Dubai (AE); Alyaa ALHAJ, Dubai (AE); Ibrahim CHIHA, Dubai (AE); Anton DUDAKOV, Dubai (AE); Mazen EL-KURDI, Dubai (AE); Vladimir MERKUREV, Dubai (AE); Sarah TOUKAN, Riyadh (SA); Talal TOUKAN, Dubai (AE)

(21) Appl. No.: 18/365,080

(22) Filed: Aug. 3, 2023

Related U.S. Application Data
(60) Provisional application No. 63/396,075, filed on Aug. 8, 2022.

(51) Int. Cl. G06Q 20/32

(52) U.S. Cl. CPC G06Q 20/326

(57) ABSTRACT

A system has a network interface circuit to provide connectivity to a network with a backend server, a gateway machine and a customer electronic device. A processor is connected to the network interface circuit. A memory is connected to the processor. The memory stores instructions executed by the processor to execute a host application. An application renders a calculator view, a keyboard view, and an attachment view in the host application. User input is received from the application. The user input is sent to the backend server. A hyperlink derived from the user input is received from the backend server. The hyperlink is sent to the customer electronic device. A notification is received from the backend server that a transaction specified at the hyperlink has been approved by the gateway machine.

### CROSS-REFERENCE TO RELATED APPLICATION

This application claims priority to U.S. Provisional Patent Application 63/396,075, filed Aug. 8, 2022, the contents of which are incorporated herein by reference.

### FIELD

The present disclosure generally relates to online payment systems and, more particularly, to methods and interfaces for facilitating online payments.

### BACKGROUND

More and more businesses, especially smaller entrepreneurial enterprises, are currently operating entirely digitally and exclusively through use of mobile devices. Such businesses may generate awareness and leads through various social network platforms, communicate with their customers through mobile chat applications, and manage their revenue and expenses all from their phone or other mobile device.

### SUMMARY

A system has a network interface circuit to provide connectivity to a network with a backend server, a gateway machine and a customer electronic device. A processor is connected to the network interface circuit. A memory is connected to the processor. The memory stores instructions executed by the processor to execute a host application. An application renders a calculator view, a keyboard view, and an attachment view in the host application. User input is received from the application. The user input is sent to the backend server. A hyperlink derived from the user input is received from the backend server. The hyperlink is sent to the customer electronic device. A notification is received from the backend server that a transaction specified at the hyperlink has been approved by the gateway machine.

### BRIEF DESCRIPTION OF THE DRAWINGS

The features, nature and advantages of the present disclosure will become more apparent from the detailed description set forth below when taken in conjunction with the drawings in which like reference characters identify correspondingly throughout and wherein:

FIG. 1 is a block diagram of an exemplary system in which a mobile virtual point of sale keyboard may be implemented to facilitate merchant transactions.

FIG. 2 illustrates a sequence of user interfaces of a merchant's mobile device generated by a host application and a virtual keyboard extension.

FIG. 3 is a flow diagram illustrating the flow of information and messages between the components of the system of FIG. 1 during backend processing in accordance with the disclosure.

FIG. 4 illustrates a sequence of user interfaces of the merchant's mobile device generated by the host application and the virtual keyboard extension.

### DETAILED DESCRIPTION

### Overview

Disclosed herein is a system enabling the generating and sending of transaction information (e.g., digital invoices) in any host application configured with a mobile virtual point of sale keyboard in accordance with the disclosure. The disclosed virtual point of sale keyboard, also hereinafter referred to as the “ZBoard” or “ZBoard extension”, may be configured with multiple components which merchants can use to customize the invoice. For example, merchants may not only send digital invoices via an encoded payment link with a specified amount but can also include a note and a Graphics Interchange Format (GIF) file of their choice. In addition, merchants can perform calculations on the ZBoard, if needed, to generate the correct amount to include in the encoded payment link.

As is discussed below, the ZBoard (also referred to as ZiiBoard) may be implemented as a self-contained software extension. ZBoard components, how they work and interact with each other, and how they work together with a companion mobile app “ZPay” (also referred to as Ziina) are discussed below.

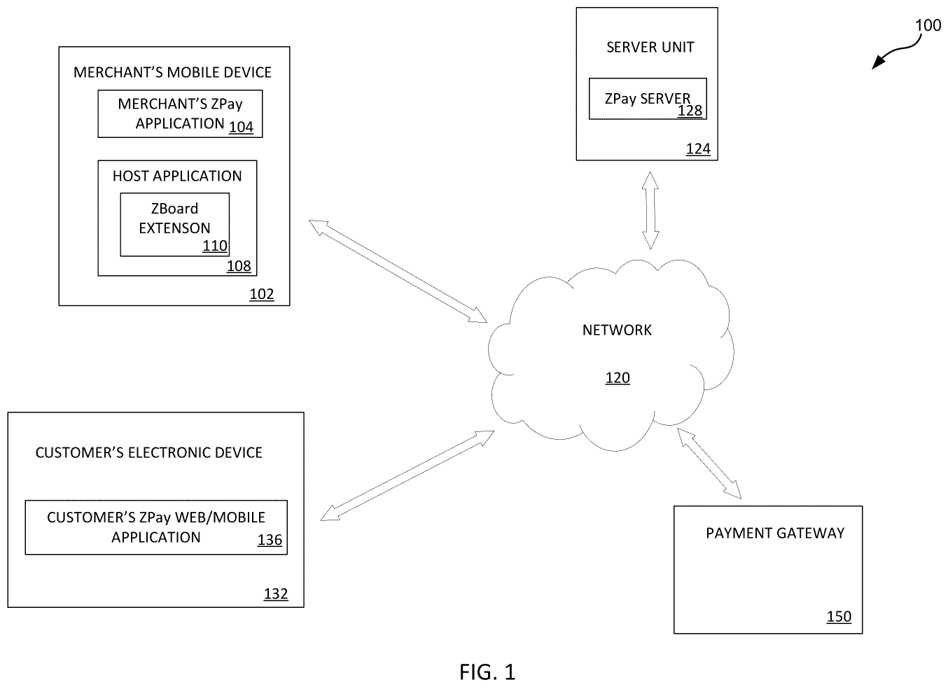

Attention is now directed to FIG. 1, which is a block diagram of an exemplary system 100 in which a mobile virtual point of sale keyboard, or ZBoard, may be implemented to facilitate merchant transactions. As shown, a merchant's mobile device 102 (e.g., a mobile phone, electronic tablet or the like) includes a ZPay application 104 and a host application 108 configured with a ZBoard extension 110. The mobile device 102 has a network interface circuit to provide connectivity to a network 120 with a backend server 124, a gateway machine 150 and a customer electronic device 132. A processor is connected to the network interface circuit. A memory is connected to the processor. The memory stores instructions executed by the processor to execute the host application 108. An application 104 and/or 110 renders a calculator view, a keyboard view, and an attachment view in the host application 108. User input is received from the application 104 and/or 110. The user input is sent to the backend server 124. A hyperlink derived from the user input is received from the backend server 124. The hyperlink is sent to the customer electronic device 132. A notification is received from the backend server 124 that a transaction specified at the hyperlink has been approved by the gateway machine 150.

The merchant's mobile device 102 communicates via the network 120 with a server unit 124 including a ZPay server 128. The network 120 may include one or more wireless and/or wired networks including the Internet. The merchant's mobile device 102 also communicates via a network 120 with a customer's electronic device 132, which may be any electronic device having electronic communication capability (e.g., a desktop or laptop PC, mobile phone, electronic tablet, etc.). The customer's electronic device 132 is configured to execute a customer ZPay application 136, which may be a Web application or a mobile app.

The merchant's mobile device 102 includes a memory with instructions executed by a processor to execute ZPay application 104 and ZBoard extension 110, so that the merchant's mobile device renders the calculator view, the keyboard view and the attachment view in the instance of the host application 108 running on the merchant's mobile device 102. These views allow the merchant to specify a transaction. The ZPay server 128 records the transaction information, associates it with a URL and sends the URL to the customer's electronic device 132. The customer's electronic device 132 views the transaction information as rendered within the customer's ZPay web/mobile application 136.

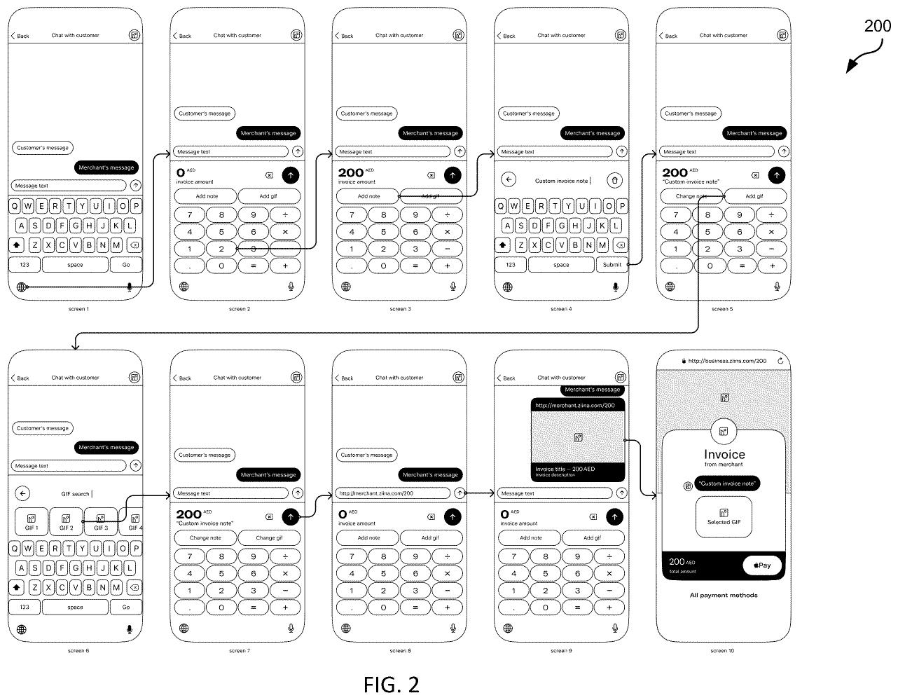

FIG. 2 illustrates a sequence of screen shots 200 of user interfaces of the merchant's mobile device 102 generated by the host application 108 and the ZBoard extension 110. Reference will be made to the screen shots 200 in describing an exemplary high-level user flow experienced by an operator of the merchant's mobile device 102 when using the ZBoard extension 110 to generate a digital invoice for a customer, i.e., an operator of the customer's electronic device 132. As may be appreciated from the screen shots 200, in the embodiment of FIG. 2, the host application 108 may comprise a mobile messaging or chat application. The ZBoard extension 110 is a self-contained software extension executed by the operating system to function within the host application 108. The high-level user flow of FIG. 2 can be described as follows:
1. Merchants can set an amount for the digital invoice and choose to add a note or add an attachment (e.g., a GIF). That is, the calculator view prompts a user for a transaction amount. The keyboard view prompts the user to enter transaction notes. The attachment view shows different attachments (e.g., GIFs) that can be associated with the transaction.
   (a) Tapping the button to add a note (screens 2 and 3 of FIG. 2) will change the view from a calculator to a standard text input virtual keyboard (screen 4 of FIG. 2). The keyboard contains the elements of the system text input keyboard, such as letters, space key, backspace, shift key, and two pages of symbols that the merchant can cycle through. The merchant can type out a note and then tap the “Done” or “Submit” button (screen 4) to include the note in the invoice.
   (b) When the keyboard is first opened, the calculator view is shown, consisting of keys for numbers and mathematical operations. The view also contains an input field to display all inputted numbers and operations. Merchants can enter a specific amount with up to two decimals places of precision. Moreover, they can use mathematical operations: addition, subtraction, multiplication, and division to calculate the correct amount. There are buttons at the top of the view for adding a note or adding a GIF (screens 2 through 4 of FIG. 2).
   (c) Tapping the button to add a GIF (screen 5 of FIG. 2) displays the note input view as well as a carousel at the top of the view for GIFs. In this mode, tapping keys on the virtual keyboard enters text into a search field for GIFs. As the merchant types, GIFs are searched against the updated search query (screen 6). When the merchant finds a GIF to include, the merchant can tap it to include it in the digital invoice (screen 6).
2. Once satisfied with the amount and optional note/GIF for their invoice, the merchant can tap the “Send” button to generate the digital invoice and insert its corresponding hyperlink into the text field of the hosting application 108 (screens 7 and 8).
3. Merchants can then transmit the digital invoice to their customer through the hosting application 108 (screens 8 and 9).
4. Once the customer device 132 receives the digital invoice, opening the hyperlink in a web browser will display the amount and optional note and GIF selected by the merchant. Screen 10 depicts the digital invoice as opened in a web browser on the merchant's mobile device 102; a substantially identical digital invoice may be rendered by a web browser on the customer's electronic device 132 upon receipt of the encoded payment link transmitted by the host application 108 on the merchant's mobile device 102. The customer then has the option to pay the invoice with either their digital wallet account (e.g., Apple Pay, Google Pay) or any supported payment card.
5. Once paid, the money is debited from the customer and made available to the merchant through the merchant's ZPay application 104. The merchant receives a push notification that the payment has been completed.

### Structural Components

The high-level structure of the ZBoard system is composed of (i) a frontend for everything related to user experience and interactions, and (ii) a backend for creating the invoice, sending back the link, and sending the invoice to be displayed on a client when the link is tapped. In addition, a third-party API is used so that merchants can search for and choose a specific attachment (e.g., GIF). In one embodiment the frontend is generally implemented by the ZBoard extension 110 and the backend is generally implemented by the ZPay server 128.

### Frontend

The frontend of the ZBoard system may be implemented on both Android and iOS platforms. However, the structural components are similar, with the difference being the language and technologies specific to developing on each of the two platforms. With that in mind, those components can be broken down to the following:
1. Entry Point:
   It's a class that introduces the mechanism by which the operating system of the merchant's mobile device 102 invokes the ZBoard extension 110 and the interface through which the ZBoard extension 110 communicates back to the hosting application 108.
   It controls which view is shown to the merchant according to user input and interactions and receives callbacks from each view with the different parts of the invoice, whether an amount, a note or an attachment.
   On tapping to send the payment link, it calls the view model to get the payment link back, then asynchronously waits for the payment link string. When it gets the value, it sends it to the operating system of the device 102 to be displayed in the merchant's hosting application 108.
2. Views: Are the screens merchants interact with, receive and process user input. See, e.g., the exemplary screen shots of FIG. 2. There are mainly three views:
   Amount/Calculator View: the first view shown when the ZBoard is opened. It enables merchants to enter numbers, make calculations and tap to send the payment link. It also links to the other two views for adding a note or a GIF.
   Keyboard or Note Input View: When it's displayed, merchants can enter and edit the note they want attached with the money amount. It consists mainly of a characters pad that handles taps on the different keys, as well as an input field on top of it to enter the note into.
   Attachment Search View: This view is very similar to the note view, except that a horizontal list of attachments (e.g., GIFs) will be displayed on top of the characters pad. While inputting a search term in the fields, the view will pass it to the view model to get the related attachments. Then, the list will be populated with the received attachments.
3. API Interface: Consists of functions that will call the backend API for the required purposes:
   Payment link API: Contains a function that will call the backend, i.e., the ZPay server 128, to create an invoice with the provided data and receives the payment link that will be passed on to the Main View Model.
   GIFs API: Contains two functions, one will get the trending GIFs from a third-party GIF service, and the second will get GIFs based on the search term inputted by the merchant from a third-party GIF service. The results of both calls are passed to the GIFs view model.
4. View Models: Are the components that take all the data processing away from views, including processing the data to be passed to/from the API interface.
   Payment link View Model: Contains a function that makes a call to the API interface, passing the invoice data, and receiving the payment link to be passed back to the view.
   Amount/Calculator View Model: The class that contains all the logic for processing the amount and the mathematical operations used on it. Implementation details for this functionality will be included in an upcoming section about handling the amount input and calculations.
   GIFs View Model: Upon viewing the GIFs screen, a function will be triggered to call the API that will get the trending GIFs. It will also receive user input and pass it with the call to the backend, to get GIFs related to that search term.

### Backend

In one embodiment, the backend API has two endpoints:
1. createInvoice, a mutation, which accepts the amount, note, and media as parameters and generates an invoice with them. It then returns a unique identifier that references that invoice.
2. getInvoice, a query, which accepts the invoice identifier as an argument and returns the corresponding amount, note and media of that invoice.

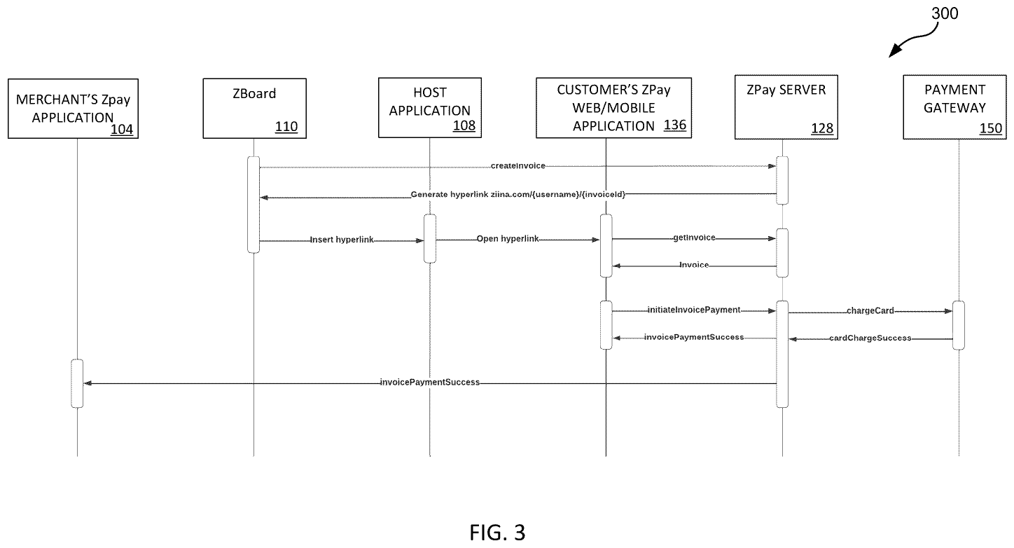

Attention is now directed to FIG. 3, which is a flow diagram 300 illustrating the flow of information and messages between the components of the system 100 during backend processing in accordance with the disclosure. As shown in FIG. 3, the ZBoard extension 110 calls the createInvoice endpoint when a merchant inputs the desired amount, note, and attachment in the keyboard interface generated by the ZBoard extension 110. The ZPay server 128 then populates the payment link with the invoice's unique identifier so that the invoice can be fetched later. The payment link is then sent to Zboard 110. The link is then sent to the host application 108 (e.g., a messaging application, a social media platform and the like). The host application 108 then opens the hyperlink, which invokes the Zpay application 136. Observe here that the system created hyperlink allows the system to be operative or otherwise be embedded into any host application without modification of the host application. Thus, the system has universal applicability without altering code in a host application.

The customer's ZPay application 136 (or web browser extension) calls the getInvoice endpoint of the ZPay server 128 with the unique identifier that is provided in the payment link to fetch, from the ZPay server 128, the invoice and all its corresponding details including the amount, note, and GIF, to display to the customer.

Once the invoice is displayed and the customer proceeds to pay it, the ZPay server 128 passes the payment method information of the customer to an endpoint initiateInvoicePayment hosted by the ZPay Server 128. The ZPay Server 128 interacts with a payment gateway 150 to charge the payment gateway and obtain confirmation of success of payment. This results in the transfer of funds from the customer's payment method (e.g., Apple Pay, Google Pay, or card) to the merchant's ZPay wallet application 104. Specifically, the ZPay server 128 does so by calling a third-party payment gateway 150 to charge the card, then once we the ZPay server 128 receives a confirmation in the form of a webhook that the charge is complete, the merchant's wallet balance is incremented and the transaction is marked as a success in an internal ledger on the ZPay server 128.

Finally, the customer can view that the payment was a success on the web page or application through which they initiated the payment, and the merchant is notified of the invoice fulfillment through a push notification from their ZPay application 104.

### Handling the Amount

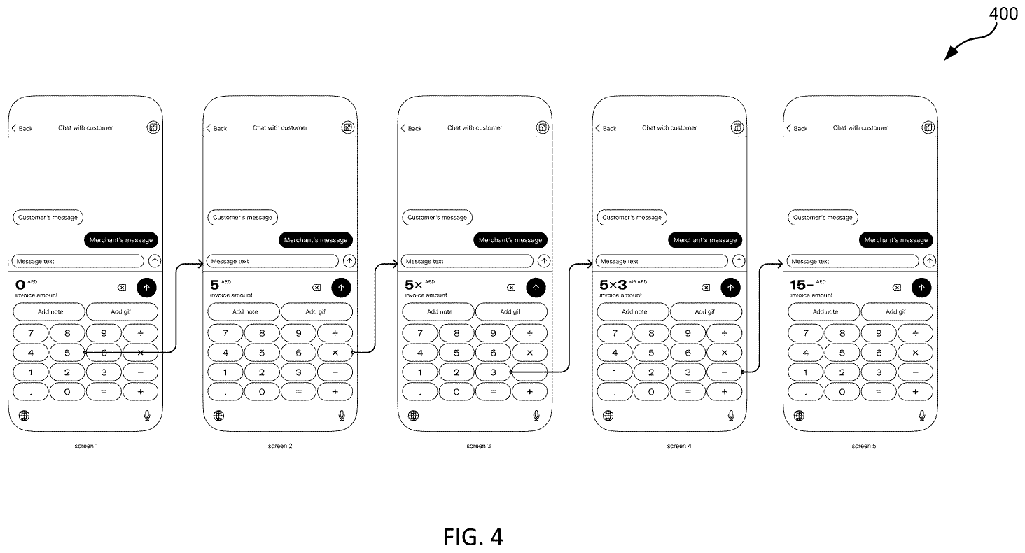

FIG. 4 illustrates a sequence of screen shots 400 of user interfaces of the merchant's mobile device 102 generated by the host application 108 and the ZBoard extension 110 to which reference will be made in describing the handling of invoice amounts. In one embodiment when the amount view is shown, there are four different buttons the merchant can use to input an amount: numbers, decimal point, operators (add, subtract, multiply, divide), and backspace.

When tapping a number (screen 1 of FIG. 4), looking at the whole input as a mathematical expression of two sides separated by an operator, it's either a left-hand side or a right-hand side. It is known to be a left-hand side if an operator has not been entered prior to entering the number (screens 1 and 2 of FIG. 4). In this case, if the merchant sends the amount, the value of the left-hand side will be the money amount for the invoice. After an operator is entered (screen 2 of FIG. 4), if a number is tapped, it is added to the right-hand side of the operator (screen 3 and 4). If the merchant sends a digital invoice with multiple terms, the result of the whole expression will be the amount for the invoice (screen 5). If another operator is selected, the first expression is evaluated and the result is made the left-hand side operator.

Merchants can also enter a decimal number with up to two decimal places. By tapping the decimal point, all the following numbers that are inputted after will be entered as decimal places. When a number is entered for a decimal place, first, the total number of decimal places will be calculated to make sure they do not exceed two. If not, the decimal place will be included to the value.

When an operator is entered, there are multiple checks to make sure the correct expression order is maintained. Those can be described in the following:
1. An operator cannot be added before entering the left-hand side, or if the left-hand side is zero.
2. When entering the operator after the left-hand side, it will be added to the expression, but no calculation will occur.
3. When entering the operator after the right-hand side, the expression will be calculated, and the result will be stored in the left-hand side with the new operator being right after.

At any time (e.g., when the merchant is done inputting and calculating the amount), the merchant can either tap to send a payment link, tap to add a note, or tap to add a GIF.

### Inputting the Note

When the button for adding a note is tapped, the amount view will be replaced with a characters pad and a field for inputting the note. That character pad is composed of multiple buttons for letters, space, backspace, shift, button to switch to symbols, and a ‘Done’ button that the merchant taps when finishing writing the note.

Each of the buttons has a tap listener that triggers a function when the button is tapped. The use of those functions is to update the note string and replacing the old string in the input field above the keypad with the new string. This functionality can be summed up as the following:
Tapping a character (letter, symbol, or space) key will trigger appending that character to the input string and viewing it in the input field.
Backspace tap will delete the last character of the input string.
Shift button tap will enable a flag that if enabled, all inputted letters will be capital letters. Otherwise, all inputted letters will be lower case.

Since in one embodiment symbols will not fit in the same display as the letters, merchants are able to tap a button that will replace letters with symbols. Tapping the same button will bring back the letters. While on the symbols screen, merchants will be able to switch between two symbol screens displaying different kinds of symbols. The function of those buttons switch between letters and characters, as well as switch between different symbol displays to enable and disable Boolean flags that will update the content of the view based on the value of those flags.

When the merchant is done inputting a note, the view is switched back to the amount view and they can tap to send a payment link, tap to add a GIF, or tap ‘Add note’ again to edit their note.

### Sending the Payment Link

On the client side, when a merchant taps on the send button the ZBoard extension 110 calls the backend API with parameters for the amount, note and GIF URL that will enable the ZPay server 128 to create the invoice and send the payment link ID back to the ZBoard extension 110. Hence, most of the processing is on the server side, i.e., is performed by the ZPay server 128.

In one embodiment all communications between the ZBoard extension 110 and the ZPay server 128 happen through an Apollo client with GraphQL queries and mutations. Accordingly, in order to create an invoice and send back a payment link, the ZBoard extension 110 makes a mutation sending the parameters:
1. User's ID that identifies him/her in the application's database, and which will be sent as a String data type. In one embodiment this information is encoded in a JSON Web Token (JWT) that is included as a header with the API call.
2. Amount which will be sent as a Money object, which is composed of units (Integer), nanos (Integer), and currency code (String).
3. The message that the merchant wishes to include with the invoice. It is an optional field that will be sent as a String.
4. The media, which is the chosen GIF. It is an optional field and will be sent as a String of the GIF's URL.

After the server 128 receives the mutation, a new record will be added to a database table maintained by the server unit 124 that is specific to these invoices. This table includes columns for each of the previously mentioned parameters, and will record the received data, each part in the respective column.

In case the new invoice record was added to the database table successfully, a payment link is generated in the form of: pay.ziina.com/{username}/{invoice id}, the id being the record's primary key in the database. After that, this link will be sent back to the ZBoard extension 110 and sent to the merchant's hosting application 108.

Alternatively, another way ZBoard can send payment links without making a call to the server 128, is by storing a template for the invoice link and customizing it with the amount and other information entered by the merchant. The link can be in the form of: pay.ziina.com/{username}?amount={enteredAmount}&note={enteredNote}, and tapping it will direct the recipient to an invoice prefilled with that information.

### Showing the Invoice

When the payment link is tapped by its recipient, another backend API will be called. The invoice ID included in the link will be used to fetch it with all its appropriate fields, like amount, note, and GIF, from the database.

Upon receiving the response containing the invoice data, there are two possible scenarios:
1. If the recipient has the ZPay application installed, they will be redirected to an invoice screen in the app, populated with the amount, message, and GIF where they can complete the payment using their wallet or payment method of choice (including Apple Pay, Google Pay, or card).
2. If they do not have the application installed, they will be redirected to a webpage containing all the details of the invoice. The customer can then fulfill the invoice payment using Apple Pay, Google Pay, or any card. Once the payment is complete, the merchant who sent the invoice will be notified accordingly.

Observe that the Merchant's ZPay application 104 and Customer's ZPay application 136 implement the keyboards disclosed herein. That is, the keyboard is not implemented by the underlying operating system, which is the typical way a user interacts with a keyboard on a mobile device. Consequently, the ZPay applications 104 and 136 may be implemented as a single code stack that is operative on different devices utilizing different operating systems.

Where methods described above indicate certain events occurring in certain order, the ordering of certain events may be modified. Additionally, certain of the events may be performed concurrently in a parallel process when possible, as well as performed sequentially as described above. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required in order to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of”and “consisting essentially of” shall be closed or semi-closed transitional phrases, respectively, as set forth in the United States Patent Office Manual of Patent Examining Procedures, Section 2111.03.

1. A system, comprising:
a network interface circuit to provide connectivity to a network with a backend server, a gateway machine and a customer electronic device;
a processor connected to the network interface circuit; and
a memory connected to the processor, the memory storing instructions executed by the processor to:
execute a host application,
execute an application that renders a calculator view, a keyboard view, and an attachment view in the host application,
receive user input from the application,
send the user input to the backend server,
receive from the backend server a hyperlink derived from the user input,
send the hyperlink to the customer electronic device, and
receive notification from the backend server that a transaction specified at the hyperlink has been approved by the gateway machine.

2. The system of claim 1 wherein the user input specifies transaction details.

3. The system of claim 2 wherein the hyperlink supplies the transaction details in a web browser.

4. The system of claim 1 wherein the calculator view prompts a user for a transaction amount.

5. The system of claim 1 wherein the keyboard view prompts the user for transaction notes.

6. The system of claim 1 wherein the attachment view displays available Graphics Interchange Format (GIF) files.

7. The system of claim 1 wherein the backend server includes instructions executed by a second processor to coordinate communications with the gateway machine.

8. The system of claim 1 wherein the backend server includes instructions executed by a second processor to coordinate communications with the customer electronic device.

9. The system of claim 1 wherein the customer electronic device includes instructions executed by a third processor to execute the application.

10. The system of claim 1 further comprising instructions executed by the processor to receive a report that the transaction is completed.
